(19) United States
(12) Patent Application Publication
(10) Pub. No.: US 2010/0266459 A1
(43) Pub. Date: Oct. 21, 2010

(54) SILICONE-CONTAINING COATING WHICH IS EFFECTIVE AGAINST POLLEN

(76) Inventor: Anne Jurjen Osinga, Rockanje (NL)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/682,386

(22) PCT Filed: Jun. 27, 2008
(86) PCT No.: PCT/NL2008/050428

§ 371 Date: Jun. 9, 2010

(30) Foreign Application Priority Data
Oct. 12, 2007 (NL) 2000925

(51) Int. Cl. B01J 31/12; C08G 77/04; A62B 7/10

(52) U.S. Cl. 422/122; 528/10; 502/158

(57) ABSTRACT

There is disclosed a coating comprising a silicone composition and a preparation by means of which the surface resistance of the coating is adjusted. The preparation is a platinum complex comprising about 5 ppm platinum metal. Such a coating is highly suitable for use as a pollen coating in filter or screen gauze material and feels good when touched by hand.

The present invention relates to a coating comprising a silicone composition.

The present invention relates to a use of said coating, in which the coating is to be incorporated in or applied to a fabric or tissue.

Such a coating is known from WO 2003/054062. The content of said patent specification shall be considered to be fully incorporated herein. The coating that is known therefrom concerns a water-based suspension of crosslinked silicone particles and a water-based emulsion of oil that contains crosslinked silicone particles. Such coatings are used in cosmetic articles and in certain types of environmentally friendly paint.

The object of the invention is to extend the field of application of such coatings.

In order to accomplish that object, the coating according to the invention is characterised in that the coating comprises a preparation by means of which the surface resistance of the coating is adjusted.

A corresponding feature relates to the use of said coating for the purpose of capturing particles that cause irritation or allergic reactions, for example pollen, germs, spores and the like from air flowing past and/or through said fabric or tissue.

It has surprisingly been found that although a silicone-containing coating repels pollen particles, the addition thereto of a preparation by means of which the surface resistance can be adjusted makes it possible to influence the charge on the surface of the coating. After all, a low surface resistance causes a charge on the surface to drain off, whilst a high surface resistance keeps the electrostatic charge thereon intact. Said charge furthermore appears to have a polarity opposed to that of the particles that cause irritation or allergic reactions, for example pollen, germs, and spores, so that the coatings according to the invention appear to be able to capture said particles in an effective manner from passing air.

A preferred composition of the coating according to the invention, which will be described in more detail hereinafter, and which is explained in particular in paragraph [42] of WO 2003/054062, moreover feels dry to the touch with the fingers.

The coating that contains the silicone composition and the preparation by means of which the surface resistance can be controlled comprises a metal or a metal compound as the preparation. The latter is known to conduct the electric charge well, depending on the concentration of the metal or the metal compound. This applies in particular in the case of a preparation yet to be explained hereinafter, which is a platinum complex.

In practice it is preferable if the amount of platinum metal in the preparation ranges between 1.5 and 15 ppm in relation to the silicone composition. Said amount in particular ranges between 3 ppm and 7 ppm, more in particular about 5 ppm in relation to the silicone composition. The formulation of the latter composition and the preparation thereof will be discussed in more detail hereinafter.

Preferably, a crosslinked silicone composition is used as the silicone composition.

In practical applications of the coating, a fabric or tissue is drenched in the coating or the coating is sprayed or atomized over the fabric or the tissue. Said fabric or tissue may also be impregnated with the coating. The fabric or the tissue can be used specifically as a filter, gauze or screen material in particular for use in windows and entrance openings, such as doors, for removing the particles that cause irritation or allergic reactions, such as pollen, germs, spores and the like from the air flowing therethrough. After all, said particles are attracted by the coating, which has a charge opposed to that of the particles, and subsequently adhere thereto and/or to the coating film in the fabric and/or the tissue.

The filter material provided with the coating may for example be used in pollen filters, for example in vehicles such as automobiles, or airplanes, and in air-conditioning units or air or pollen filters, for example.

An especially preferred coating for use as a ‘pollen coating’ is the coating described in paragraph 42 of WO 2003/054062. The details of said coating are as follows:

94.8 weight parts dimethylvinylsiloxy-endblocked dimethylpolysiloxane (400 mm²/s) containing 2.5 wt. % of an approximately 20 mm²/s mixture of dimethylsiloxane cyclics was mixed to homogeneity with 5.2 weight parts trimethylsiloxy-endblocked dimethylsiloxane methylhydrogensiloxane copolymer (50 mm²/s, silicon-bonded hydrogen content=0.31 wt. %, this quantity provided a value of 0.95 for the molar ratio of the silicon-bonded hydrogen to the vinyl in the dimethylpolysiloxane). To this was then added an aqueous solution of 30 weight parts pure water and 1.0 weight part polyoxyethylene hexyldecyl ether (NIKKOL BH-10 from Nikko Chemicals Co., Ltd., ethylene oxide adduct of isocetyl alcohol of vegetable oil origin, number of moles of ethylene oxide addition=10, HLB=13.4, liquid at room temperature) followed by emulsification using a colloid mill and then dilution with 30 weight parts pure water to give a water-based silicone composition emulsion.

A water-based platinum catalyst emulsion with an average particle size of 0.2 μm was prepared as follows: 1 weight part of a 1,3-divinyltetramethyldisiloxane and isopropyl alcohol mixed solution of a 1,3-divinyltetramethyldisiloxane complex of platinum was stirred to homogeneity into an aqueous solution of 27 weight parts ion-exchanged water and 0.3 weight part of the above-identified polyoxyethylene hexyldecyl ether (NIKKOL BH-10 from Nikko Chemicals Co. Ltd., number of moles of ethylene oxide addition=10, HLB=13.4, liquid at room temperature).

The water-based platinum catalyst emulsion was stirred to homogeneity, in this specific case in an amount that provided 5 weight ppm platinum metal in relation to the silicone composition, into the water-based silicone composition emulsion prepared as described above. This was followed by holding at quiescence for one day to give a water-based suspension of crosslinked silicone particles through the hydrosilylation-induced crosslinking of the silicone composition. The average particle size of the crosslinked silicone particles in the resulting water-based suspension was 4.4 m (90% particle size 7.5 m), and the suspension stability, the height of the water layer, was 10 mm, whilst the surfactant HLB, which is the weighted average value when two species of surfactants were used, was 13.4.

It has been found that in particular the platinum material acts as a catalyst and at the same time places an electrostatic charge on the silicone particles. Said charge uniformly attracts the pollen, whilst subsequently the light charge of the silicone emulsion keeps the pollen in place. It has been found that the formation of a film around the fibres of the gauze is important with a view to keeping the pollen in place as well as possible. The precious metal platinum has a varying oxidation step of +4 and +2 and an electronegativity of 2.28, resulting in a rather large attraction on small floating pollen. The advantage is that platinum does not decay with the passage of time and retains its advantageous characteristics for the application in question, even after the gauze is washed. Furthermore it hardly reacts with oxygen in the air or in the water, and consequently does not oxidise.

1. A coating comprising a silicone composition, characterised in that the coating comprises a preparation by means of which the surface resistance of the coating is adjusted.

2. A coating according to claim 1, characterised in that said preparation contains a metal and/or a metal compound.

3. A coating according to claim 1 or 2, characterised in that said preparation is a platinum complex.

4. A coating according to any one of claims 1-3, characterised in that the amount of platinum metal in the preparation ranges between 1.5 and 15 ppm in relation to the silicone composition, in particular between 3 ppm and 7 ppm, more in particular about 5 ppm.

5. A coating according to any one of claims 1-4, characterised in that said silicone composition is a crosslinked composition.

6. Use of the coating according to any one of claims 1-5 for being incorporated in or applied to a fabric or tissue, characterised in that the purpose of said use is to capture particles that cause irritation or allergic reactions, for example pollen, germs, spores and the like from air flowing past and/or through said fabric or tissue.

7. Use according to claim 6, characterised in that said fabric or said tissue is incorporated in a filter, a gauze or a screen to which the coating has been applied and/or in which the coating has been impregnated.

8. Use according to claims 6 and 7, characterised in that said fabric or said tissue has been passed through a coating bath and/or that the coating has been sprayed thereon.

9. Use according to any one of claims 6-8, characterised in that the coating can be used for removing electrically charged particles that cause irritation or allergic reactions, such as pollen, germs, spores and the like from air by exposing the same to the coating having an opposite charge.

10. Filter, gauze or screen material provided with a coating according to any one of claims 1-5.
